(19) United States
(12) Patent Application Publication
(10) Pub. No.: US 2011/0036065 A1
(43) Pub. Date: Feb. 17, 2011

(54) LAWN MOWER POWERED BY A COMPRESSION-IGNITED COMBUSTION ENGINE THAT CAN USE MULTIPLE FUEL TYPES

(76) Inventors: Yen Wen Wong, Dongguan (CN); Mark Wong, Dongguan (CN); Sam Horatio Lancaster Andrews, Dongguan (CN)

Correspondence Address: MICHAEL RIES, 318 PARKER PLACE, OSWEGO, IL, 60543, US

(21) Appl. No.: 12/854,577

(22) Filed: Aug. 11, 2010

Related U.S. Application Data
(60) Provisional application No. 61/232,879, filed on Aug. 11, 2009.

(51) Int. Cl. A01D 34/00

(52) U.S. Cl. 56/10.1

(57) ABSTRACT

The present invention is a lawn mower with a compression ignition combustion engine that can use multiple fuel types such as petroleum based fuels or plant based fuels or any combination thereof. The lawn mower includes a chassis with a rear end having a plurality of spaced wheels, a compression ignited engine mounted on the chassis to provide power to the lawn mower and a plurality of grass cutting blades mounted directly or indirectly on an output shaft of the compression ignited engine. The lawn mower also includes a handle projecting from the rear end of chassis and a fuel tank and a fuel line supported by the chassis to provide the multiple fuel types to the compression ignited engine.

This application claims priority to U.S. Provisional Application 61/232,879 filed on Aug. 11, 2009, the entire disclosure of which is incorporated by reference.

### TECHNICAL FIELD & BACKGROUND

This invention is concerning of a type of walk-behind lawnmower which is powered by a single cylinder compression-ignited combustion engine. This engine can use multiple types of fuels such as diesel, clean diesel, esterified plant oil and non-esterified plant oil, as well as other types of fuels.

Currently on the market, most walk-behind lawnmowers are powered by spark-ignited combustion engines. An object of the invention is to provide a walk-behind lawnmower powered by a compression-ignited combustion engine. For a long time, both spark-ignited and compression-ignited engines were fueled by liquid petroleum-derived fuels and were used in similar applications. The main difference between these two types of engines is the methods of initiating fuel combustion. Spark-ignited engines rely upon an external source of energy to initiate the combustion of fuel and air within the engine cylinder. This energy is provided by a spark plug as the terminal element in the engine's electrical ignition system. The compression-ignited engines rely upon the fuel to self-ignite upon reaching the proper air/fuel ratio, temperature, and pressure. Apart from the fact that compression-ignited engines are more fuel efficient the other advantage is that these engines can be adapted to use multiple types of fuels. These fuels include petroleum diesel, clean petroleum diesel such as ULSD (ultra-low sulfur diesel), synthetic diesel, gas to liquid diesel, kerosene, home heating oil, civil jet fuel, military jet fuel, esterified plant oil, non-esterified plant oil, and any mixed blends of these fuels.

It has been identified there are more than 1000 oil producing plants around the world. One of the advantages of using esterified and non-esterified plant oil as engine fuels compared to using petroleum-based engine fuels is the reduction of greenhouse gases such as the amount of carbon monoxide and carbon dioxide to be released into the atmosphere. In the whole world, pollution caused by using lawn and gardening equipment can not be neglected. In the United States alone, this type of pollution is about 5% of its national total pollution. Furthermore, plant oil, esterified or non-esterified, as a fuel is a biomass fuel and is considered to be carbon neutral. Walk-behind lawnmowers have relatively less working intensity and working life compared to road related vehicles. These characteristics make it possible to use a compression-ignited engine with plant oil as a fuel. This is because some of the problems in association with burning non-esterified plant oil (such as carbon and fatty acid built-up) are not so severe. Non-esterified plant oil includes pure plant oil (PPO), straight vegetable oil (SVO), used cooking oil (UCO) and waste vegetable oil (WVO). Esterified plant oil is mostly regarded as plant oil (both used and non-used) being processed to become biodiesel.

Most compression-ignited combustion engines, directly injected (DI) or indirectly injected (IDI) can run on all abovementioned fuels without any modification. However, to run on non-esterified plant oil, some minor modifications to the engines are required. One of the objects of the invention is to overcome the abovementioned problems in association with burning non-esterified plant oil by providing a type of walk-behind lawnmower which is powered by compression-ignited engines that not only can use petroleum-derived fuels but also can use esterified and non-esterified plant oil as fuel.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side diagonal perspective view of a lawn mower powered by a compression-ignited combustion engine that can use multiple fuel types, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

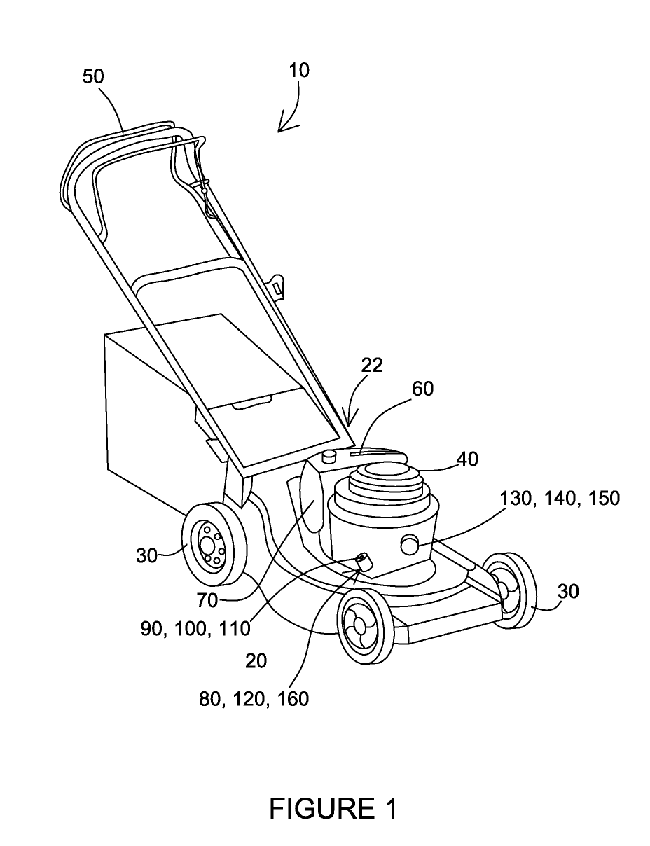

FIG. 1 illustrates a side diagonal perspective view of a lawn mower powered by a compression-ignition combustion engine that can use multiple fuel types 10, in accordance with one embodiment of the present invention. The lawn mower which is powered by a compression-ignition combustion engine that can use multiple fuel types 10 can use petroleum and plant oil based fuels or any combination of petroleum and plant oil based fuels. The lawn mower which is powered by a compression-ignition combustion engine that can use multiple fuel types 10 also includes a chassis 20 having spaced wheels 30, a compression ignition engine 40 mounted on the chassis 20, a plurality of grass cutting blades (not shown) mounted directly or indirectly on the engine's output shaft (not shown), a handle 50 projecting from the rear end 22 of the chassis 20 and a fuel tank 60 supported by the chassis 20 or the compression ignition engine 40 for providing fuel to the compression ignition engine 40. The compression ignition engine 40 can run on multiple types of fuels. Some modifications or optional features can be applied to the compression ignition engine 40 to improve the efficiency of using non-esterified plant oil as fuel.

In one embodiment of the present invention, in the fuel tank 60 of the abovementioned compression ignition engine 40 there is an electrical heater 70 to heat the non-esterified plant oil. To more effectively run on non-esterified plant oil, the compression-ignited engine 40 can have a single pintle single hole injector 80 with a bowl-shaped recess 90 on its piston top 100 used for direct fuel injection. For more effectively running on non-esterified plant oil, the abovementioned compression ignition engine 40 can also have a single pintle single hole injector 80 and an insulated piston top 110 for use in indirect fuel injections.

Alternatively, for more effective running on non-esterified plant oil, the abovementioned compression ignition engine 40 can also have a single pintle single hole 80 and multi-hole injector 120 and an insulated piston top 110 used in indirect fuel injections. At the air in-taking port 130 of the abovementioned compression-ignited engine 40, there can also be forced air induction. The forced air induction can improve the burning efficiency of all types of fuels including non-esterified plant oil. A forced air induction is provided and is designed based on either turbo charging powered by the engine's exhausted gases 140 or as mechanical supercharging powered by the engine's output shaft 150 or as air blowing powered by a battery 160.

The lawn mower powered by a compression ignition combustion engine that can use multiple fuel types 10 provide compression ignition engines 40 which use esterified and non-esterified plant oil as fuel. Plant oil as fuel when burned is carbon neutral and therefore has no or limited contribution to the greenhouse effect. The compression ignition engine 40 is simple and small enough to be feasible for large scale production. The lawn mower powered by a compression-ignition combustion engine that can use multiple fuel types 10 is a type of walk-behind lawnmower, although other types of lawn mowers that are well known in the art can also be used in combination with compression ignition engines 40 that can use multiple types of fuels such as a self-propelling lawn mower.

In one embodiment, the lawn mower powered by a compression ignition combustion engine that can use multiple fuel types 10 uses a single cylinder 4-stroke compression-ignition combustion engine 42. The single cylinder 4-stroke compression ignition combustion engine 42 is designed to be able to run on multiple types of fuels petroleum based and plant based. The single cylinder 4-stroke compression ignition combustion engine 42 has a relatively smaller capacity <<25 kW) but is relatively efficient on fuel. For more efficiently using non-esterified plant oil, the single cylinder 4-stroke compression ignition combustion engine 42 has electrical heaters 70 in the fuel tank 60 and along the fuel lines (not shown) to heat the non-esterified plant oil fuel prior to being injected into the combusting chamber, thus the viscosity of the fuel is reduced. Higher quality filtration has been applied before and after the fuel pump (not shown) and fuel pump pressure has also been increased.

In the single cylinder 4-stroke compression ignition combustion engine 42, the direct fuel injection method together with a specially designed a single point or throttle body injection nozzle 160 are used for the single cylinder 4-stroke compression ignition combustion engine 42 engine. A bowl-shaped recess 90 on the piston top 100 is used to incorporate the single point or throttle body injection nozzle 160 to improve burning of the non-esterified plant oil fuel. In another embodiment, either direct injection or indirect injection together with the insulated piston tops 110 can also be designed and used for an improved burning of the non-esterified plant oil fuel. All these measures are aiming to overcome the problems of non-esterified plant oil burning in a compression ignition engine 40. A forced air induction to increase the pressure of in-taking air for the compression ignition engine 40 can also be added to the single cylinder 4 stroke compression ignition engine 42. This will further improve the burning of all types of fuels in the compression ignition engine 40 and the single cylinder 4 stroke compression ignition engine 42. The lawn mower powered by a compression ignition combustion engine that can use multiple fuel types 10 is designed based on turbo charging power 140 by the engine's exhausted gases, mechanical supercharging power 150 by the engine's output shaft and air blowing powered by a battery 160.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A lawn mower that can use multiple fuel types, comprising:
a chassis with a rear end having a plurality of spaced wheels;
a compression ignited engine mounted on said chassis to provide power to said lawn mower;
a plurality of grass cutting blades mounted directly or indirectly on an output shaft of said compression ignited engine;
a handle projecting from said rear end of chassis; and
a fuel tank and a fuel line supported by said chassis to provide said multiple fuel types to said compression ignited engine.

2. The lawn mower according to claim 1, wherein said compression ignited engine includes a heater in said fuel tank and said fuel lines to heat said non-esterified plant oil.

3. The lawn mower according to claim 2, wherein said compression ignited engine includes a single pintle single hole injector with a piston with a top for direct said fuel injection.

4. The lawn mower according to claim 3, wherein said compression ignited engine includes a single pintle multi-hole injector with a piston with a top for direct said fuel injection.

5. The lawn mower according to claim 4, wherein said injectors includes a bowl shaped recess on said piston top.

6. The lawn mower according to claim 2, wherein said compression ignited engine includes a single pintle single or multi hole injector with a piston with a top for indirect said fuel injection.

7. The lawn mower according to claim 6, wherein said injector includes an insulated said piston top.

8. The lawn mower according to claim 1, wherein said compression ignited engine provides forced air induction designed based on turbo charging power by said compression ignited engine exhausted gases, mechanical supercharging power by said compression ignited engine's output shaft or air blowing powered by a battery.

9. The lawn mower according to claim 1, wherein said lawn mower is a walk behind lawn mower either pushed or self propelled.

10. The lawn mower according to claim 1, wherein multiple fuel type is selected from the group multiple fuel types consisting of petroleum based fuels, plant based fuels, any combination of petroleum based or plant based fuels, plant oil, non-esterified plant oil or esterified plant oil.

11. A lawn mower that can use multiple fuel types, comprising:
a chassis with a rear end having a plurality of spaced wheels;
a single 4 cylinder compression ignited combustion engine mounted on said chassis to provide power to said lawn mower;
a plurality of grass cutting blades mounted directly or indirectly on an output shaft of said compression engine;
a handle projecting from said rear end of chassis; and
a fuel tank and a fuel line supported by said chassis to provide said multiple fuel types to said engine.

12. The lawn mower according to claim 11, wherein said engine includes a heater in said fuel tank and said fuel lines to heat said non-esterified plant oil.

13. The lawn mower according to claim 12, wherein said engine includes a single pintle single hole injector nozzle with a piston with a top for direct said fuel injection.

14. The lawn mower according to claim 13, wherein said engine includes a single pintle multi-hole injector nozzle with a piston with a top for direct said fuel injection.

15. The lawn mower according to claim 14, wherein said nozzles includes a bowl shaped recess on said piston top.

16. The lawn mower according to claim 12, wherein said engine includes a single pintle single hole injector with a piston with a top for indirect said fuel injection.

17. The lawn mower according to claim 16, wherein said injector includes an insulated said piston top.

18. The lawn mower according to claim 11, wherein said engine provides forced air induction designed based on turbo charging power by said engine exhausted gases, mechanical supercharging power by said engine's output shaft or air blowing powered by a battery.

19. The lawn mower according to claim 11 wherein said lawn mower is a walk behind lawn mower either pushed or self propelled.

20. The lawn mower according to claim 11, wherein multiple fuel type is selected from the group multiple fuel types consisting of petroleum based fuels, plant based fuels, any combination of petroleum based or plant based fuels, plant oil, non-esterified plant oil or esterified plant oil.
